(19) United States
(12) Patent Application Publication
(10) Pub. No.: US 2025/0052965 A1
(43) Pub. Date: Feb. 13, 2025

(54) MOLDING APPARATUS AND DEVICE FORMED BY MOLDING APPARATUS

(71) Applicant: Taiwan Semiconductor Manufacturing Company, Ltd., Hsinchu (TW)

(72) Inventor: Chien-Ling Hwang, Hsinchu City (TW)

(73) Assignee: Taiwan Semiconductor Manufacturing Company, Ltd., Hsinchu (TW)

(21) Appl. No.: 18/446,484

(22) Filed: Aug. 9, 2023

(51) Int. Cl. G02B 6/42; B29C 45/14; B29C 45/26; B29C 45/37

(52) U.S. Cl. CPC G02B 6/4255; B29C 45/14819; B29C 45/2606; B29C 45/372; G02B 6/4224; G02B 6/4239; G02B 6/4245; B29L 2011/0075

(57) ABSTRACT

A molding apparatus includes a mold chase and a sensor. The mold chase includes an upper portion and a lower portion engaged with the upper portion to form a cavity therebetween for receiving a workpiece. The upper portion includes a top surface and an alignment mark on the top surface. A pattern is provided on at least one of inner surfaces of the upper and lower portions. The sensor facing the mold chase is configured to detect the alignment mark of the upper portion and a position of the workpiece in the mold chase.

### BACKGROUND

Optical signals are usable for various applications including high speed and secure data transmission between devices. In some applications, a device capable of optical data transmission includes one or more optical or electrical components, one or more waveguides for transmitting and/or receiving optical signals, and a support on which the IC is mounted. Because the light passes through the optical components, it is important that the optical components are positioned accurately for guiding the light toward the associated components. Although existing devices are generally adequate for their intended purposes, they are not satisfactory in all aspects.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic cross-sectional view of an apparatus for a molding process, in accordance with some embodiments.

FIGS. 2A through 2C illustrate schematic cross-sectional views of various stages in a manufacturing method for a semiconductor device, in accordance with some embodiments.

FIGS. 3A and 3B illustrate schematic cross-sectional views of various stages in a manufacturing method for an optical component, in accordance with some embodiments.

FIG. 3C illustrates a schematic cross-sectional view of a semiconductor structure including the optical component, in accordance with some embodiments.

FIGS. 4A through 4C illustrate schematic cross-sectional views of various stages in a manufacturing method for a semiconductor device, in accordance with some embodiments.

FIGS. 5A through 5E illustrate schematic cross-sectional views of various stages in a manufacturing method for a semiconductor device, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a second feature over or on a first feature in the description that follows may include embodiments in which the second and first features are formed in direct contact, and may also include embodiments in which additional features may be formed between the second and first features, such that the second and first features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath”, “below”, “lower”, “on”, “over”, “overlying”, “above”, “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the packaging of integrated circuits, devices (e.g., chips, dies, electronic components, etc.) are encapsulated with a molding layer to isolate the devices from the external environment. For example, a molding process is performed by using a mold apparatus including a mold chase, where the mold chase is configured to receive a moldable material for configuring the devices into a package. The conventional mold chase has flat inner surfaces such that the resulting molded structure formed by the mold chase has flat top/side surfaces. If optical components have to be integrated on the molded structure, one or more processes (e.g., aligning, bonding, coupling, etc.) should be performed on the molded structure. In addition, in order to couple optical signals to optical components, optical components (e.g., mirrors, waveguides, couplers, etc.), must be precisely aligned with respect to the optical input/output interfaces. However, the alignment accuracy of the conventional mold chase may not meet the requirements.

The present disclosure is related to an optical component, a semiconductor device having an optical component, a molding apparatus designed to fabricate the optical component or the semiconductor device, and a manufacturing method for forming the same. The manufacturing method described herein provides a robust device with light-guide element(s) through imprinting by using the molding apparatus. By using the molding apparatus described herein, the optical component may be fabricated to high accuracy so that the demand for the precise alignment/integration in the fabricated device may be achieved, and the processes for coupling the optical component(s) to the molded structure may be omitted. The variations of the embodiments are discussed. Throughout the various views and illustrative embodiments, like reference numbers are used to designate like components.

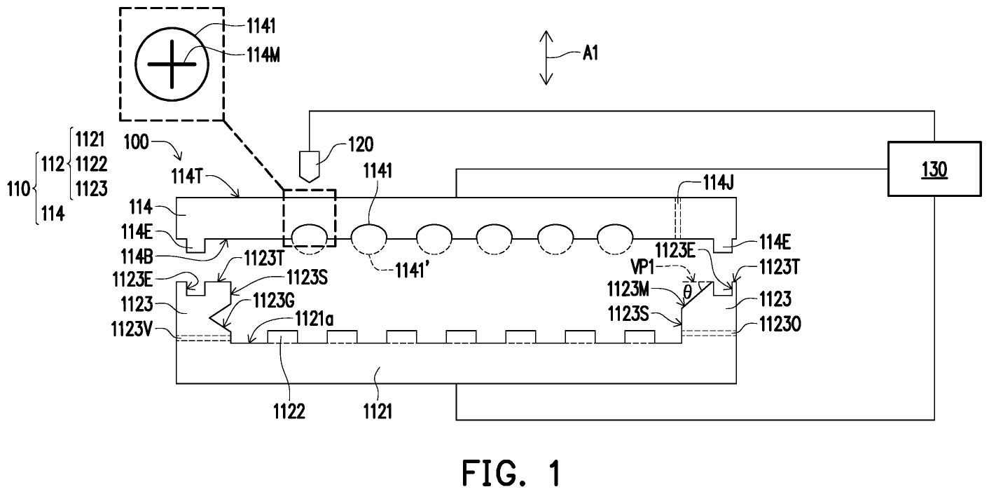

FIG. 1 illustrates a schematic cross-sectional view of an apparatus for a molding process, in accordance with some embodiments. Referring to FIG. 1, a molding apparatus 100 includes a mold chase 110. The mold chase 110 may include a lower portion 112 and an upper portion 114 that are configured to be engaged with each other to form a cavity therebetween. In some embodiments, the lower portion 112 is connected to a lower support (not shown), and the lower support may be configured to adjust a position of the lower portion 112 before and/or during the operation of the molding process. The lower support may be (or include) a movable stage including a driving unit (e.g., motor, controller, and processor, etc.; not shown) for adjusting an x position, a y position, a z position, and/or an angular position of the lower portion 112. In some embodiments, the x, y, z, and θ direction of the lower portion 112 is corrected by tuning of alignment controlled by the lower support.

In some embodiments, the lower portion 112 includes a base 1121 and at least one protrusion 1122 protruding upwardly from the top surface 1121a of the base 1121 (i.e. one of the inner surfaces of the lower portion 112). For example, a plurality of protrusions 1122 is arranged to form a pattern on the top surface 1121a of the base 1121. In some embodiments, the protrusions 1122 are detachably adhered to the top surface 1121a of the base 1121. In some embodiments, the protrusions 1122 and the base 1121 are integratedly formed. The protrusions 1122 and the base 1121 may be of the same material or different materials. For example, a suitable material of the lower portion 112 includes stainless steel, aluminum, ceramic, a combination thereof, or the like. The dashed line between the base 1121 and the protrusions 1122 indicates that an interface therebetween may or may not exist. Alternatively, the protrusions 1122 are omitted, and the top surface 1121a of the base 1121 remains substantially planar and flat.

In some embodiments, the lower portion 112 includes walls 1123 on the edge region of the base 1121. The walls 1123 and the base 1121 may be of the same material or different materials. In some embodiments, a groove 1123G is provided on the inner surface 1123S of at least one of the walls 1123. For example, the groove 1123G is defined by two of inclined facets shaped in a horizontal V-groove form, as shown in the cross-sectional view of FIG. 1. The groove 1123G may have other suitable cross-sectional profile. In some embodiments, a venting port 1123V is provided on at least one of the walls 1123 and formed as an opening on the wall 1123 through which the inner space of the mold chase 110 is communicated with the outer space outside of the mold chase 110. For example, a vacuum pump (not shown) is connected to the venting port 1123V. During the operation of the molding process, air may be vacuumed from the inner space of the mold chase 110 through the venting port 1123V. The groove 1123G and the venting port 1123V may (or may not) be provided on the same wall 1123. Alternatively, the groove 1123G and/or the venting port 1123V may be omitted.

In some embodiments, one of the walls 1123 includes a slanted surface 1123M sloped from the top surface 1123T of the wall 1123 to the inner sidewall 1123S of the walls 1123. For example, an angle θ is between the slanted surface 1123M and the virtual plane VP1 where the top surface 1123T is located on. The angle θ may be about 45 degrees. In some embodiments, the angle θ is of about, e.g., 30 degrees, 60 degrees, etc. Other value of the angle θ is fully intended to be included within the scope of the embodiments. Alternatively, the slanted surface 1123M is omitted. In some embodiments, an overflow port 1123O is provided on at least one of the walls 1123 and formed as an opening on the wall 1123 through which the inner space of the mold chase 110 is communicated with the outer space outside of the mold chase 110. For example, during the operation of the molding process, excess portions of the moldable material may overflow from the inner space of the mold chase 110 to the outer space through the overflow port 1123O. The overflow port 1123O and the venting port 1123V may (or may not) be provided on the different (e.g., opposing or adjacent) walls 1123. Alternatively, the overflow port 1123O is omitted.

With continued reference to FIG. 1, the lower portion 112 may be engaged with the upper portion 114 through a pair of engagement parts (e.g., 1123E and 114E) provided on the periphery of the mold chase 110. For example, the lower portion 112 includes a receiving part 1123E provided on the top surface 1123T of at least one of the walls 1123, and the upper portion 114 includes a protruding part 114E provided on a bottom surface 114B of the upper portion 114 and corresponding to the receiving part 1123E. In some embodiments, the protruding part 114E acts as the positioning pin protruding from the bottom surface 114B of the upper portion 114, and the receiving part 1123E acts as the matching groove recessed from the top surface 1123T of the lower portion 112. In alternative embodiments, the upper portion 114 includes a receiving part and the lower portion 112 includes a protruding part matching the receiving part. During the molding process, the protruding part 114E becomes engaged with receiving part 1123E, allowing the upper portion 114 to be positioned and aligned with respect to the lower portion 112. In some embodiments, the engagement parts (e.g., 1123E and 114E) provide the mold chase 110 with a positioning precision on the order of a few tens of microns.

In some embodiments, the upper portion 114 is connected to an upper support (not shown) that is configured to adjust a position of the upper portion 114 before and/or during the operation of the molding process. The upper support may be (or include) a robotic arm including a driving unit (e.g., motor, controller, and processor, etc.; not shown) for adjusting an x position, a y position, a z position, and/or an angular position of the upper portion 114. In some embodiments, the x, y, z, and θ direction of the upper portion 114 is corrected by tuning of alignment controlled by the upper support. The upper portion 114 may be formed of any suitable material with high transmittance, such as acrylic polymer, glass, a combination thereof, the like, or other suitable transparent material. During the molding process, the light is able to illuminate through the upper portion 114 to reach the inner space of the mold chase 110 for precise alignment. The transparency of the upper portion 114 may improve the alignment of the pattern of the mold chase (e.g., recesses 1141) and the workpiece to be processed due to increased visibility.

In some embodiments, at least one recess 1141 is provided on the bottom surface 114B of the upper portion 114. For example, a plurality of recesses 1141 is arranged to form a pattern on the bottom surface 114B. The recesses 1141 may be concave from the bottom surface 114B toward the top surface 114T of the upper portion 114 so that the recesses 1141 are shaped in a concave-curved form in the cross-sectional view of FIG. 1. In some other embodiments, the convex pattern 1141′ is provided on the bottom surface 114B and shaped in a convex-curved form in the cross-sectional view, as indicated by the dashed lines. Alternatively, the recesses 1141 (or the convex pattern 1141′) may be omitted, and the bottom surface 114B of the upper portion 114 remains substantially planar and flat. In some embodiments, a release film (not shown) is conformally attached to the inner surfaces of the upper portion 114 and/or the inner surfaces of the lower portion 112 to facilitate the molded structure released from the mold chase 110.

With continued reference to FIG. 1, the upper portion 114 may include at least one alignment mark 114M provided on the top surface 114T. In the enlarged top view, the alignment mark 114M may be located within a boundary of the respective recess 1141. By configuring the alignment mark 114M, the recesses 1141 may be aligned with the workpiece to be processed before and/or during the molding process. In some embodiments, at least one recess/groove is recessed from the top surface 114T to serve as the alignment mark 114M. In some embodiments, at least one protrusion is protruded from the top surface 114T to serve as the alignment mark 114M. In the top view, the alignment mark 114M may have any suitable shape such as a rectangular shape, a cross shape, an elliptical shape, an oval shape, a polygon shape, a combination thereof, etc. It should be appreciated that the shape, the number, the location, and the size of the alignment mark illustrated in FIG. 1 are merely examples, and the disclosure is not limited thereto.

In some embodiments, at least one injection port 114J is provided on the upper portion 114 and formed as the opening through which the inner space of the mold chase 110 to the outer space outside of the mold chase 110. For example, a molding material is injected into the mold chase 110 through the injection port 114J during the molding process. The injection port 114J may be disposed on the peripheral region of the upper portion 114 or may be disposed on the central region of the upper portion 114. The location and the number of the injection port 114J are merely examples, and the disclosure is not limited thereto. Alternatively, the injection port 114J is omitted.

Still referring to FIG. 1, the molding apparatus 100 may include at least one sensor 120 disposed over the upper portion 114 of the mold chase 110 and facing the alignment mark 114. The sensor 120 may be configured to detect and/or monitor a position of the workpiece to be processed relative to the alignment mark 114, before (and/or during) the molding process. For example, the sensor 120 is configured to emit the light source (not shown) towards the alignment mark 114M of the upper portion 114, so that when positioning the workpiece to be processed in the mold chase 110, a relative position of the workpiece to be processed and the alignment mark 114M may be detected and/or monitored by the sensor 120. In some embodiments, the sensor 120 is used as a mark recognition device for detecting the alignment mark 114M, so that the position of the workpiece to be processed relative to the alignment mark 114M may be determined based on the detecting result of the sensor 120. In some embodiments, the engagement parts (e.g., 1123E and 114E) are used for coarse alignment of the workpiece to be processed, and the precision alignment of the workpiece to be processed may be performed by using the sensor 120, where the coarse alignment may be less exacting as compared to the precision alignment. For example, the accuracy of the precision alignment is in the submicron level.

The sensor 120 may be or include a charge coupled device (CCD) image sensor, a complementary metal oxide semiconductor (CMOS) image sensor, or any other operable instruments to detect the alignment mark 114M and/or the alignment mark on the workpiece to be processed. In some embodiments, the sensor 120 is configured to monitor the workpiece to be processed in real time. It should be noted that the sensor 120 may include any suitable type of monitoring and detection equipment depending on process demands. In some embodiments, the sensor 120 is integratedly mounted on the mold chase 110. Alternatively, the sensor 120 is independently installed proximate to the mold chase 110. In some embodiments where the lower portion 112 has a suitable transparent material and is provided with the alignment mark, the sensor 120 is disposed below the mold chase 110 and faces the lower portion 112 of the mold chase 110. It should be noted that the number and the configuration of the sensor 120 are an illustrative example, and other number and configurations are possible.

In some embodiments, the molding apparatus 100 includes at least one operating device 130 controllably operating the sensor 120 and the upper and lower portions (112 and 114) of the mold chase 110. For example, the operating device 130 includes a controller, a user interface, a network interface, a computer readable storage module (e.g., a memory and/or data store), and other suitable component(s) for performing various acts/operations. For example, the operating device 130 is configured to control the movement and/or alignment of the sensor 120 and the upper and lower portions (112 and 114) of the mold chase 110. As indicated by the two way vertical arrow A1 in FIG. 1, the upper and lower portions (112 and 114) of the mold chase 110 may open (e.g., the upper portion 112 may be moved away from the lower portion 114) and close (e.g., the upper portion 112 may be moved close to the lower portion 114) for loading and unloading of the workpiece to be processed (open for these steps), and for molding and curing (close for these steps). In some embodiments, the operating device 130 is configured to control the timing of the injection/vacuuming through the corresponding ports (e.g., 114J and 1123V). It should be understood that in FIG. 1, the details of the molding apparatus 100 has been simplified and is provided for illustrative purposes only, and other embodiments may utilize fewer or additional elements.

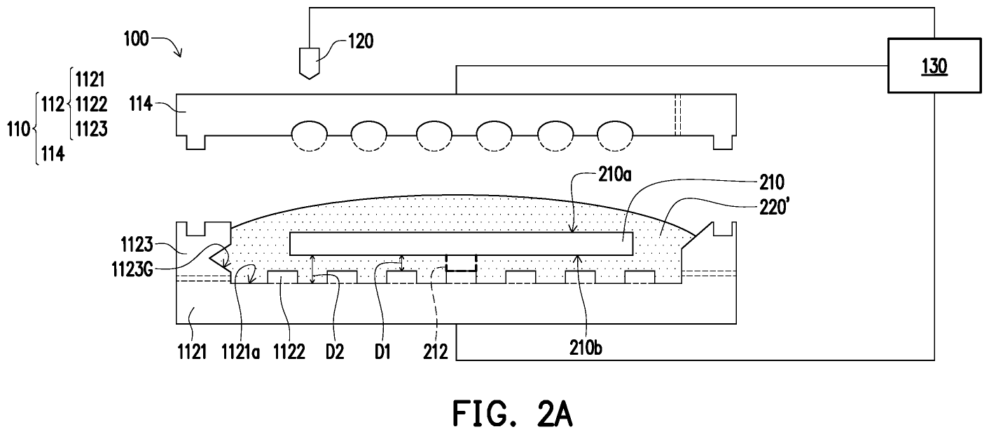

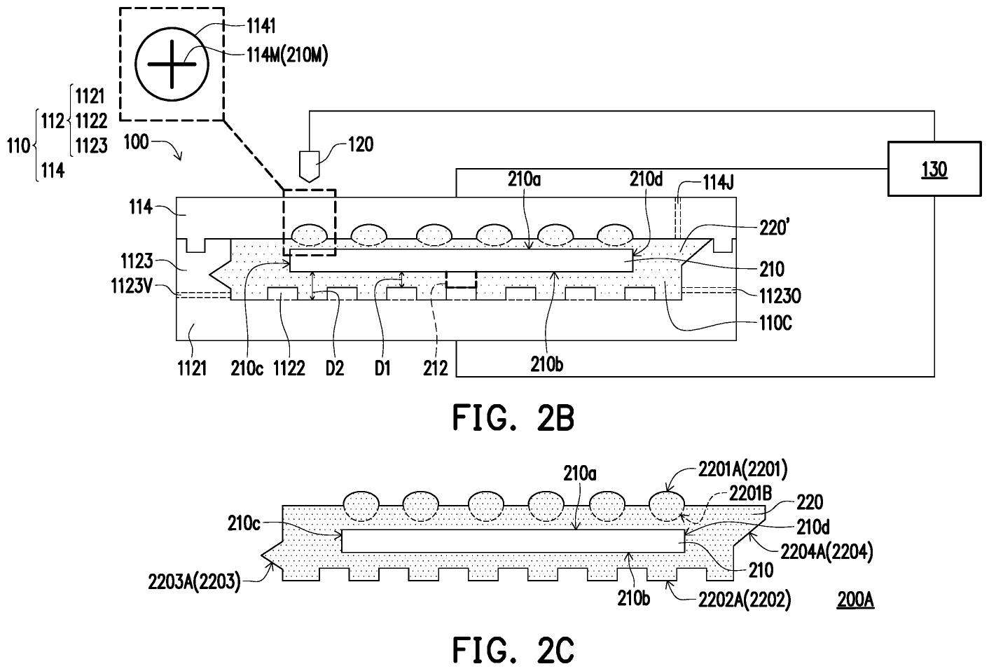

FIGS. 2A through 2C illustrate schematic cross-sectional views of various stages in a manufacturing method for a semiconductor device using the molding apparatus 100, in accordance with some embodiments. It should be noted that the molding process described in the following embodiments may be performed in a wafer-level, a panel-level, a chip-level, or the like, depending on process and product requirements.

Referring to FIG. 2A and with reference to FIG. 1, the mold chase 110 is in the open state and may receive and load the workpiece 210. For example, the workpiece 210 has a portion 212 provided on a bottom surface 210b and physically abutting the lower portion 112 (e.g., one or more the protrusion(s) 1122 and/or the base 1121). The portion 212 of the workpiece 210 is illustrated in the dashed line to indicate it may not be seen in this cross-sectional view, but exists in a certain cross-sectional view. The other portion of the bottom surface 210b of the workpiece 210 may be over and spaced apart from the protrusions 1122 of the lower portion 112 by a first non-zero distance D1, and a second non-zero distance D2 is between the bottom surface 210b and the base 1121. A moldable material 220′ may be formed on the lower portion 112, and the workpiece 210 may be covered by the moldable material 220′ through, e.g., dispensing, injecting, or any suitable technique. In some embodiments, the workpiece 210 is disposed on the lower portion 112, and then the moldable material 220′ is dispensed to cover the workpiece 210. In some embodiments, the moldable material 220′ is dispensed on the lower portion 112, and then the workpiece 210 is placed on the lower portion 112 and embedded in the moldable material 220′. During the dispensing/injecting of the moldable material 220′, the flow rate of the moldable material 220′ may be controlled such that the possibility of the formation of voids in moldable material 220′ may be reduced.

The workpiece 210 may be a device wafer which includes a plurality of device dies including active devices (e.g., transistors or the like), passive devices (e.g., resistors, capacitors, inductors, or the like), optical devices (e.g., receivers, transmitters, couplers, modulators, detectors, splitters, converters, switches, or the like), a combinations thereof, etc. The workpiece 210 may include a substrate made of any suitable semiconductor material (e.g., silicon; germanium; a compound semiconductor including silicon carbide, gallium arsenic, gallium phosphide, indium phosphide, indium arsenide, and/or indium antimonide; an alloy semiconductor including SiGe, GaAsP, AlInAs, AlGaAs, GaInAs, GaInP, and/or GaInAsP; or combinations thereof). The workpiece 210 may include photonic integrated circuit (PIC), electronic integrated circuit (EIC), at least one optical fiber, a combination thereof, or the like. In some embodiments, at least one optical pathway (e.g., photonic interconnect or the like) is formed in the workpiece 210. It should be understood that in FIGS. 2A-2C, FIGS. 4A-4C, and FIGS. 5A-5E, the details of the workpiece that is to be subjected to the molding process have been simplified.

The moldable material 220′ may be or include an epoxy based compound, a silicone based compound, an acrylic based compound, or the like. The moldable material 220′ may have a designed refractive index depending on product requirements. For example, the moldable material 220′ is an optical resin, an optical glue/grease, or other suitable moldable material that can provide optical transparency and mechanical support. In some embodiments, the moldable material 220′ is applied while substantially liquid, and may be cured in the subsequent process.

Referring to FIG. 2B and with reference to FIG. 2A, the mold chase 110 is in the close state, for example, the operating device 130 controls one of the upper portion 114 and the lower portion 112 to be engaged with the other one of the upper portion 114 and the lower portion 112. When the upper portion 114 and the lower portion 112 are brought together, a cavity 110C may be formed between the lower portion 112 and the upper portion 114, thereby defining a shape for the moldable material 220′. After the mold chase 110 is close, the excess portion of the moldable material 220′ may overflow from the inner space 110C of the mold chase 110 to the outer space through the overflow port 1123O. In alternative embodiments, the workpiece 210 is first placed in position, and then the moldable material 220′ is injected into the inner space (or the cavity) 110C of the mold chase 110 through the injection port 114J after the upper portion 114 and the lower portion 112 are brought together.

In some embodiments, a two-step alignment is performed to align the workpiece 210 with at least the recesses 1141 of the upper portion 114 through the operation(s) of the operating device 130. For example, a coarse alignment is performed by bringing the lower portion 112 and the upper portion 114 together. For example, the operating device 130 controls one of the receiving part 1123E and the protruding part 114E to be engaged with the other one of the receiving part 1123E and the protruding part 114E. In some embodiments, a fine (or precision) alignment is performed by using the sensor 120 to regulate the position of the workpiece 210 relative to the mold chase 110. The operating device 130 coupled to the sensor 120 is configured to control the regulation and/or alignment. For example, the light source (not shown) of the sensor 120 emits toward and through the alignment mark 114M provided on the upper portion 114 and the alignment mark 210M provided on the workpiece 210 for detecting and feeding back a relative position of the upper portion 114 and the workpiece 210. The position of the upper portion 114 and/or the workpiece 210 may be adjusted based on the detecting results. In some embodiments, the upper portion 114 is moved by the upper support (not shown; e.g., the robotic arm) controlled by the operating device 130 to align the alignment mark 114M of the upper portion 114 with the alignment mark 210M on the workpiece 210. In some embodiments, the workpiece 210 physically abutting the lower portion 112 is moved by the lower support (not shown; e.g., the movable stage) controlled by the operating device 130 to align the alignment mark 210M of the workpiece 210 with the alignment mark 114M of the upper portion 114. By using the two-step alignment, the workpiece 210 may be precisely positioned at the predetermined position in the mold chase 110.

In some embodiments, after the mold chase 110 is close, pressure may be exerted (e.g., by a pressure supply device; not shown) to press the upper portion 114 against the lower portion 112. The workpiece 210 may thus be enclosed with the moldable material 220′. Alternatively, no external pressure is applied to the mold chase 110. In some embodiments, the cavity 110C of the mold chase 110 is vacuumed through the venting port 1123V after the alignment so that the pressure of the cavity 110C of the mold chase 110 may be lowered. When the inner space 110C of the mold chase 110 is vacuumed, the moldable material 220′ may spread out in the mold chase 110 until the entirety of the cavity 110C of the mold chase 110 is filled with the moldable material 220′. With the venting/vacuuming through the venting port 1123V, it is less likely to have air bubbles (or voids) formed in the moldable material 220′. Alternatively, the venting/vacuuming is omitted, as long as the moldable material 220′ is well-dispensed without the formation of bubbles/voids therein.

In some embodiments, the moldable material 220′ is cured by a curing process or any suitable means, and the moldable material 220′ is solidified. The curing process may include exposing the moldable material 220′ with radiation (e.g., ultra-violet (UV) light), applying the thermal energy to the moldable material 220′, or other suitable technique depending on the property of the moldable material 220′. The space having the first non-zero distance D1 and the second non-zero distance D2 between the workpiece 210 and the lower portion 112 may be filled with the moldable material 220′. In some embodiments, the top surface 210a, the bottom surface 210b, and the sidewalls (210c and 210d) connected to the top surface 210a and the bottom surface 210b are covered by the moldable material 220′.

Referring to FIG. 2C and with reference to FIG. 2B, the mold chase 110 may be open, and the molded structure may be released from the mold chase 110, where the molded structure may be a semiconductor device 200A. For example, the semiconductor device 200A includes the workpiece 210 and an optically molded layer 220 wrapping around the workpiece 210. The semiconductor device 200A may be an optically molded product. For example, the mold chase 110 serving as an imprint mold may imprints one or more pattern(s) in the moldable material 220′. In this manner, at least one side of the optically molded layer 220 may form a light-guide element (e.g., micro-lens, a mirror, a grating coupler, a waveguide, and/or any suitable optical path changer, etc.). The optically molded layer 220 may be transparent to the optical signals communicable between the light-guide element and the workpiece 210. The number and the location of the light-guide element provided by the optically molded layer 220 may correspond to the shape of the inner surfaces of the mold chase 110.

In some embodiments, a first surface 2201 of the optically molded layer 220 includes a protruding pattern functioning as a first light-guide element (e.g., micro-lens) 2201A. In alternative embodiments, the first surface 2201 includes a recessed pattern (illustrated in the dashed line) functioning as concave lens 2201B, where the recessed pattern may be formed by using the convex pattern 1141′ shown in FIG. 1. In some alternative embodiments, the first surface 220 includes the protruding pattern located in a region and the recessed pattern located in another region. The top surface 210a of the workpiece 210 may be directly below the first surface 2201 of the optically molded layer 220 and include the optical I/O portion (or interface; not individually shown) optically aligned with (or coupled to) the first light-guide element 2201A (or 2201B).

In some embodiments, a second surface 2202 of the optically molded layer 220 opposite to the first surface 2201 includes a concave-convex pattern functioning as a second light-guide element (e.g., a grating coupler) 2202A. The bottom surface 210b of the workpiece 210 may be directly over the second surface 2202 of the optically molded layer 220 and include the optical I/O portion (or interface; not individually shown) optically aligned with (or coupled to) the second light-guide element 2202A. In some embodiments, a third surface (e.g., a sidewall) 2203 connected to the first and second surfaces (2201 and 2202) has a horizontal protruding pattern functioning as a third light-guide element (e.g., a V-groove coupler) 2203A. The sidewall 210c of the workpiece 210 may face the third surface 2203 of the optically molded layer 220 and include the optical I/O portion (or interface; not individually shown) optically aligned with (or coupled to) the third light-guide element 2203A.

In some embodiments, a fourth surface (e.g., a sidewall) 2204 opposite to the third surface 2203 has a slanted facet functioning as a third light-guide element (e.g., a reflector or a mirror) 2204A. For example, the mirror has a tilt angle of 45 degrees. It should be noted that the tilt angle of the third light-guide element 2204A may be adjusted by changing the angle θ as shown in FIG. 1. The sidewall 210d of the workpiece 210 may face the fourth surface 2204 of the optically molded layer 220 and include the optical I/O portion (or interface; not individually shown) optically aligned with (or coupled to) the fourth light-guide element 2204A. Although the optically molded layer 220 in the cross-sectional view of FIG. 2C shows four light-guide elements formed at four sides, other embodiments may utilize fewer (or additional) light-guide elements or other types of light-guide elements, depending on product requirements. The number and the type of the optical I/O portion (or interface) of the workpiece 210 may be changed correspondingly based on the light-guide elements of the optically molded layer 220, depending on product requirements.

In some embodiments, a portion or all of the light-guide elements (e.g., 2201A, 2201B, 2202A, 2203A, and 2204A) is optically coupled to the workpiece 210 to transmit light to or receive light from the light source or optical signal source, where the light source or optical signal source may be provided as an external component optically coupled to the semiconductor device 200A or may be a photonic dies (not individually shown) in the workpiece 210. In some embodiments, the workpiece 210 and the light-guide elements (e.g., 2201A, 2201B, 2202A, 2203A, and 2204A) are collectively formed as an optical engine structure.

It is appreciated that high accuracy is an important requirement of an optical structure. By using the molding apparatus 110 having at least one pre-formed pattern (e.g., 1141, 1141′, 1123G, 1122, and/or 1123M), at least one light-guide element (e.g., 2201A, 2201B, 2202A, 2203A, and/or 2204A) of the optically molded layer 220 may be accurately formed at the predetermined positions. In addition, by using the two-step alignment during the molding process, the workpiece 210 may be accurately positioned with respect to the light-guide elements (e.g., 2201A, 2201B, 2202A, 2203A, and 2204A) of the optically molded layer 220. Further, the molding apparatus 100 may be used in mass production, and the processing steps for forming the semiconductor device may be reduced while manufacturing yields may be increased.

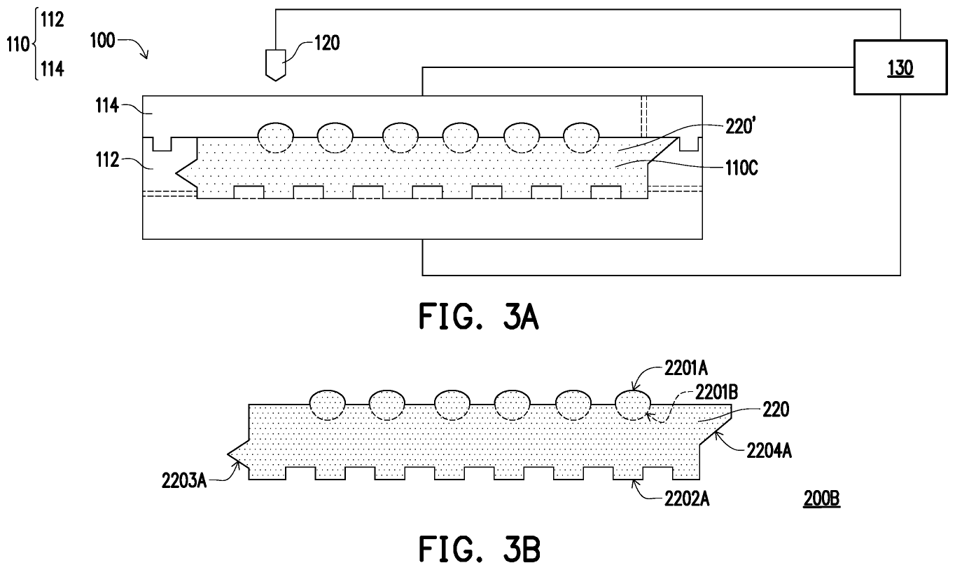

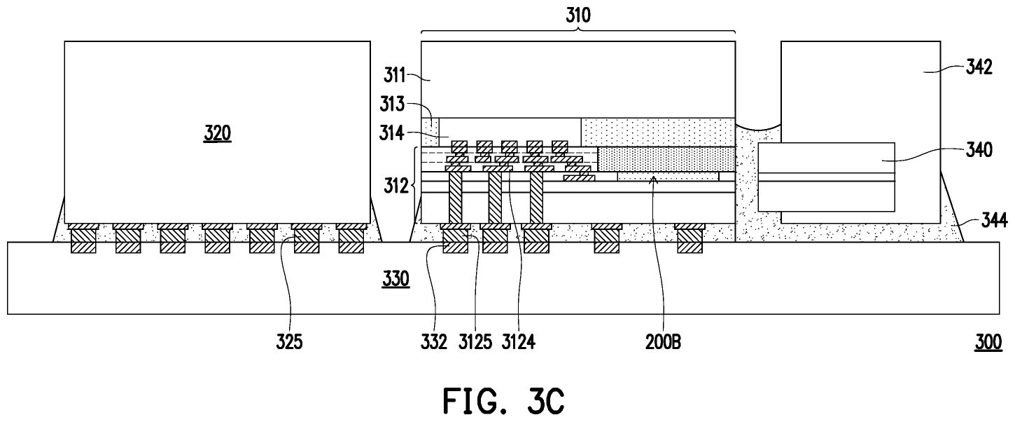

FIGS. 3A and 3B illustrate schematic cross-sectional views of various stages in a manufacturing method for an optical component by using the molding apparatus 100, in accordance with some embodiments. Unless specified otherwise, like reference numerals in this embodiment represent like components in the embodiment shown in FIGS. 2A-2C formed by like processes. Accordingly, the process steps and applicable materials may not be repeated herein.

Referring to FIG. 3A and with reference to FIG. 2B, forming the optical component 200B is to employ the mold chase 110 to imprint the moldable material 220′ with the curing process. For example, the moldable material 220′ may fill the inner space 110C of the mold chase 110, and then a curing process may be performed to solidify the moldable material 220′. The process at this stage is similar to the processes described in FIGS. 2A-2B, except that the placement/alignment of the workpiece is omitted. In some embodiments, the fine alignment using the sensor 120 is omitted.

Referring to FIG. 3B and with reference to FIG. 3A and FIG. 2C, after the curing, the molded structure may be released from the mold chase 110, where the molded structure may be an optical component 200B. The optical component 200B may be similar with the semiconductor device 200A, except that the optical component 200B is free of workpiece (e.g., device wafer/die). The optical component 200B may be a combination of various light-guide elements (e.g., 2201A, 2201B, 2202A, 2203A, and 2204A). As mentioned in the preceding paragraphs, although the optical component 200B in the cross-sectional view of FIG. 3B shows four light-guide elements formed at four sides, other embodiments may utilize fewer (or additional) light-guide elements or other types of light-guide elements, depending on product requirements.

FIG. 3C illustrates a schematic cross-sectional view of a semiconductor structure including the optical component 200B, in accordance with some embodiments. Referring to FIG. 3C and with reference to FIG. 3B, a semiconductor structure 300 including the optical component 200B is provided. For example, the semiconductor structure 300 is a photonic system. The semiconductor structure 300 may include one or more photonic packages 310 and one or more semiconductor devices 320 that are attached to a circuit substrate 330. The photonic package 310 may act as an input/output (I/O) interface between optical signals and electrical signals in the photonic system. For example, the photonic package 310 facilitates optical communication between semiconductor devices 320 and external devices, optical networks, or the like. The optical component 200B may be integrated into the photonic package 310. The optical power may be provided to the optical component 200B by, e.g., an optical fiber 340 coupled to an external light source (not shown), or the optical power may be generated by a photonic component (e.g., diode; not shown) within the photonic package 310. The details of the optical component 200B in FIG. 3C has been simplified and is provided for illustrative purposes only, and the number and the configuration of the optical component 200B may be adjusted depending on the product requirements.

In some embodiments, the semiconductor structure 300 combines the semiconductor device 320 and the photonic package 310 on the circuit substrate 330 that allows for interfacing with one or more optical fibers 340. In some embodiments, the optical fiber 340 is supported by a fiber holder 342 and may be attached to the circuit substrate 330 and/or the photonic package 310 by an optical glue layer 344 or the like. In some embodiments, the optical fiber 340 is aligned with and optically coupled to the optical component 200B in the photonic package 310 by adjusting the position of the optical fiber 340.

In some embodiments, the photonic package 310 includes a support 311, a PIC die 312, and an EIC die 314 interposed between the support 311 and the PIC die 312, where the optical component 200B may be disposed within the PIC die 312. The EIC die 314 and the PIC die 312 may be electrically connected through one or more electrical connections 3124. The electrical connections 3124 may include conductive lines, conductive vias, conductive pads, through vias, etc. In some embodiments, the electrical connections 3124 may be electrically connected to contact pads 332 of the circuit substrate 330 through conductive joints 3125 (e.g., solder joints). In some embodiments, the photonic package 310 includes an encapsulant 313 interposed between the support 311 and the PIC die 312 and laterally covered by the EIC die 314.

The semiconductor device 320 may be or include an IC die, a system-on-chip (SoC) device, a system-on-integrated-circuit (SoIC) device, a package, the like, or a combination thereof. The semiconductor device 320 may include one or more processing devices, such as a central processing unit (CPU), a graphics processing unit (GPU), an application-specific integrated circuit (ASIC), a high performance computing (HPC) die, the like, or a combination thereof. The semiconductor device 320 may include one or more memory devices, which may be a volatile memory such as dynamic random-access memory (DRAM), static random-access memory (SRAM), high-bandwidth memory (HBM), another type of memory, or the like. The semiconductor device 320 may be electrically coupled to the contact pads 332 of the circuit substrate 202 through conductive joints 325, and an underfill 210 may be formed between the semiconductor device 250 and the interconnect substrate 202. It should be understood that the semiconductor structure 300 is provided for illustrative purposes only, and other embodiments may utilize fewer or additional elements.

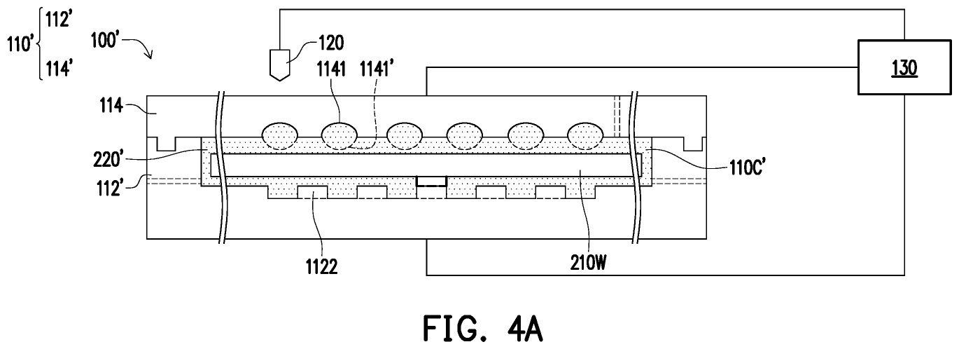

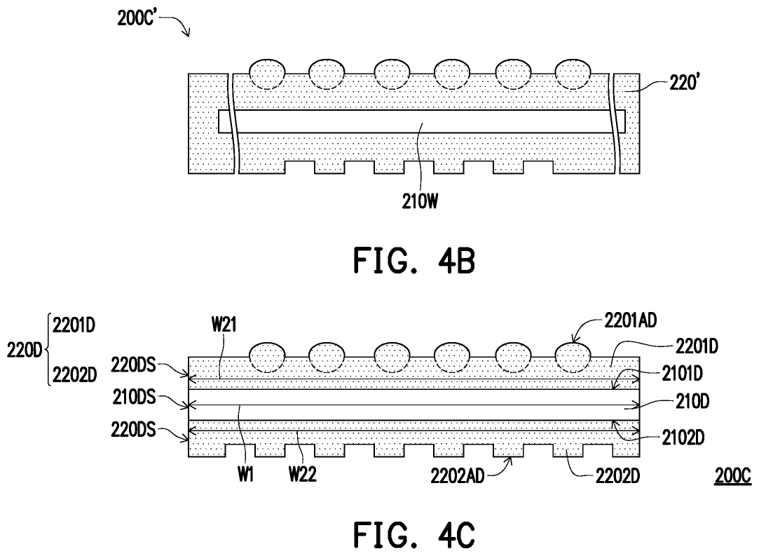

FIGS. 4A through 4C illustrate schematic cross-sectional views of various stages in a manufacturing method for a semiconductor device, in accordance with some embodiments. Unless specified otherwise, like reference numerals in this embodiment represent like components in the embodiment shown in FIGS. 2A-2C formed by like processes. Accordingly, the process steps and applicable materials may not be repeated herein.

Referring to FIG. 4A and with reference to FIGS. 1 and 2A-2B, the molding apparatus 100′ may receive and load the workpiece 210W. For example, the workpiece 210W is placed on and physically abuts the lower portion 112′ of the mold chase 110′. The workpiece 210W may be precisely aligned with the protrusion 1122 of the lower portion 112′ and the recesses 1141 (or the convex pattern 1141′) of the upper portion 114 by using the engagement parts of the mold chase 110′ and the sensor 120 controlled by the operating device 130, as mentioned in the previous embodiments. The lower portion 112′ of the mold chase 110′ may be similar to the lower portion 112 of the mold chase 110 described in FIG. 1, except that the pattern (e.g., 1123G and 1123M) provided on the walls 1123 may be omitted. The workpiece 210W is similar to the workpiece 210 described in FIG. 2A. In the present embodiment, the workpiece 210W is provided in a wafer/panel form and includes scribe lines (not shown) for the subsequently-performed singulation process. The moldable material 220′ may fill the inner space 110C′ of the mold chase 110′, and then a curing process may be performed to solidify the moldable material 220′. The process at this stage is similar to the processes described in FIGS. 2A-2B.

Referring to FIGS. 4B-4C and with reference to FIG. 4A and FIG. 2C, after the curing, the molded structure 200C′ may be released from the mold chase 110′. Next, a singulation process may be performed on the molded structure 200C′ to separate the device regions from one another so as to form individual semiconductor devices 200C. For example, a respective semiconductor device 200C includes a semiconductor die 210D and an optically molded layer 220D. The optically molded layer 220D may include a first portion 2201D overlying the first surface 2101D of the semiconductor die 210D and a second portion 2202D overlying the second surface 2102D of the semiconductor die 210D, where the first surface 2101D and the second surface 2102D are opposite to each other. In some embodiments, a lateral dimension (e.g., a width) W1 of the semiconductor die 210D is substantially equal to a lateral dimension (e.g., a width) W21 of the first portion 2201D of the optically molded layer 220D and/or a lateral dimension (e.g., a width) W22 of the second portion 2202D of the optically molded layer 220D. The sidewall 210DS of the semiconductor die 210D may be substantially aligned with the sidewall 220DS of the optically molded layer 220D, within process variations. The sidewalls 210DS and 220DS may collectively form a continuous (e.g., a straight) sidewall of the semiconductor device 200C.

In some embodiments, the upper surface of the first portion 2201D has a pattern functioning as a first light-guide element (e.g., micro-lens) 2201AD, where the first light-guide element 2201AD is optically coupled to the optical I/O portion (or interface) on the first surface 2101D of the semiconductor die 210. The pattern on the first portion 2201D may be a convex or concave pattern, similar to the descriptions associated with the first light-guide element (e.g., 2201A/concave lens 2201B) in FIG. 2C. The second portion 2202D of the optically molded layer 220D may include a pattern provided on the outer surface and functioning as a second light-guide element (e.g., a grating coupler) 2202AD, where the second light-guide element 2202AD is optically coupled to the optical I/O portion (or interface) on the second surface 2102D of the semiconductor die 210. It should be noted that the number, the configuration, and the type of the first and second light-guide elements of the optically molded layer 220D are provided for illustrative purposes only and can be modified depending on product requirements. In addition, it should be noted that although two of the light-guide elements are illustrated, the optically molded layer 220D of the semiconductor device 200C may be modified to have the first light-guide element only or include additional light-guide elements coupled to other sides/surfaces of the semiconductor die 210D, as mentioned in the previous embodiments.

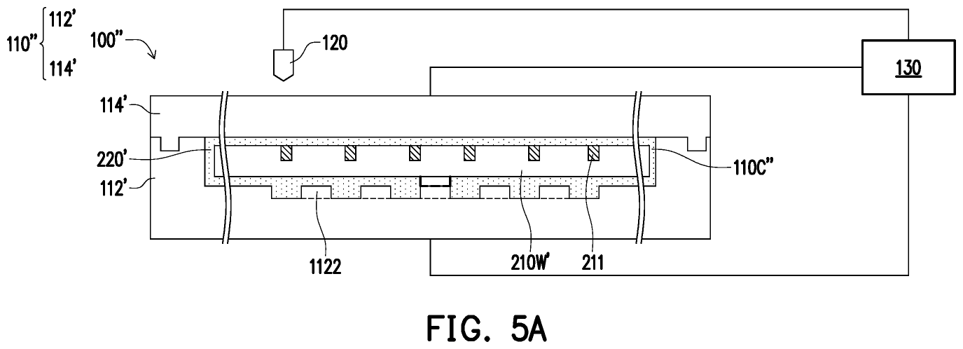

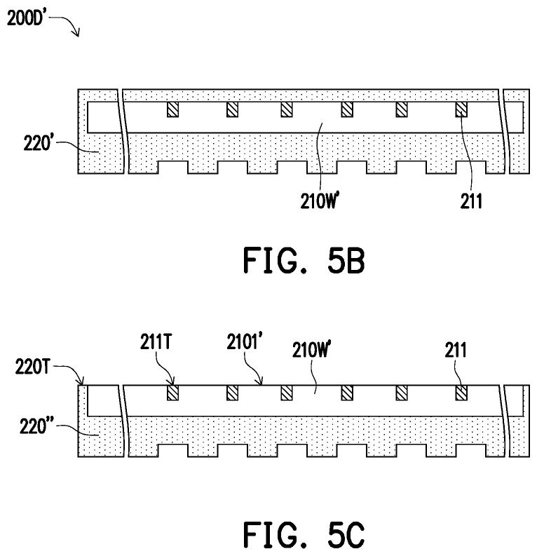

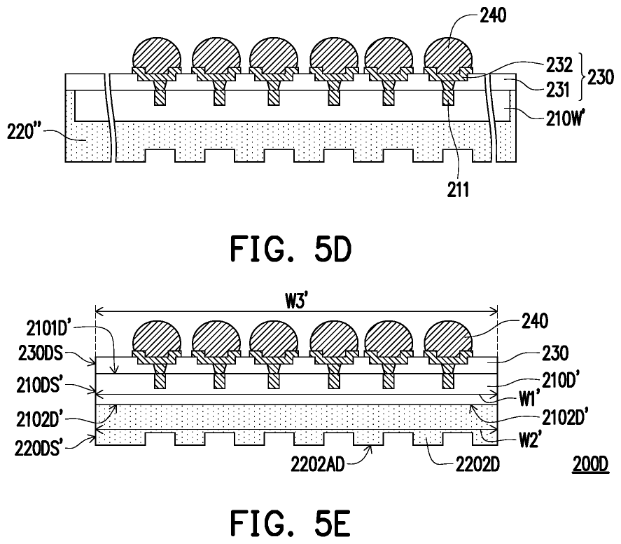

FIGS. 5A through 5E illustrate schematic cross-sectional views of various stages in a manufacturing method for a semiconductor device, in accordance with some embodiments. Unless specified otherwise, like reference numerals in this embodiment represent like components in the embodiment shown in FIGS. 2A-2C formed by like processes. Accordingly, the process steps and applicable materials may not be repeated herein.

Referring to FIG. 5A and with reference to FIGS. 1 and 4A-4C, the molding apparatus 100″ may receive and load the workpiece 210W′. For example, the workpiece 210W′ is placed on and physically abuts the lower portion 112′ of the mold chase 110″. The upper portion 114′ of the mold chase 110″ may be engaged with the lower portion 112′ to form the cavity 110C″ for accommodating the workpiece 210W′. The upper portion 114′ of the mold chase 110″ may be similar to the upper portion 114 of the mold chase 110 described in FIG. 1, except that the pattern (e.g., 1141 or 1141′) provided on the bottom surface 114B of the upper portion 114 may be omitted. The workpiece 210W′ may be aligned with the protrusion 1122 of the lower portion 112′ by engaging the upper and lower portions 114′ and 112′ through the engagement parts. The workpiece 210W′ may be precisely aligned with the protrusion 1122 of the lower portion 112′ by using the sensor 120 facing the upper portion 114′ and controlled by the operating device 130, as mentioned in the previous embodiments. In some other embodiments, the sensor 120 is disposed below the lower portion 112′ and faces the lower portion 112′ which is made of a suitable transparent material.

The workpiece 210W′ is similar to the workpiece 210 described in FIG. 2A. In the present embodiment, the workpiece 210W′ is provided in a wafer/panel form and includes scribe lines (not shown) for the subsequently-performed singulation process. The workpiece 210W′ may include at least one conductive connector 211, which may be configured to provide the electrical connection to an electrical circuitry (not illustrated) in the workpiece 210W′. In some embodiments, the workpiece 210W′ includes a plurality of device regions (not shown) defined by the scribe lines, and the conductive connectors 211 are die connectors electrically coupled to the respective integrated circuits of the device regions. In some embodiments, the workpiece 210W′ includes a substrate, and the conductive connectors 211 are embedded in the substrate and may serve as through substrate via (TSV) in the resulting structure. The workpiece 210W′ includes more conductive features and/or various elements electrically connected to the conductive connectors 211. It should be noted that the details of the workpiece 210W′ has been simplified and is provided for illustrative purposes only.

At this stage, the conductive connectors 211 may be embedded in the workpiece 210W′ or may be physically covered by the moldable material 220′. The moldable material 220′ may fill the inner space 110C″ of the mold chase 110″. The workpiece 210W′ may be covered by the moldable material 220′ in the mold chase 110″. Next, a curing process may be performed to solidify the moldable material 220′. The process at this stage is similar to the processes described in FIGS. 2A-2B.

Referring to FIGS. 5B-5C and with reference to FIG. 5A, after the curing, the molded structure 200D′ may be released from the mold chase 110″. Next, a portion of the molded material 220′ over the workpiece 210W′ may be removed to accessibly reveal the conductive connectors 211. For example, a planarization process (e.g., chemical mechanical polishing (CMP), grinding, etching, a combination thereof, etc.) is performed on the molded material 220′ to form a planarized molded material 220″. In some embodiments, a portion of the workpiece 210W′ is removed during the planarization process to expose the top surfaces 211T of the conductive connectors 211. For example, the first surface 2101′ of the workpiece 210W′ is substantially leveled (or coplanar) with the top surface 220T of the planarized molded material 220″, within process variations.

Referring to FIG. 5D and with reference to FIG. 5C, a redistribution structure 230 may be formed on the top surfaces 210T of the workpiece 210W′ and the top surface 220T of the planarized molded material 220″. For example, the redistribution structure 230 includes a dielectric layer 231 and a conductive pattern 232 covered by the dielectric layer 231. The conductive pattern 232 may include conductive lines, conductive pads, and conductive vias, and may be electrically and physically connected to the conductive connectors 211. Next, a plurality of conductive bumps 240 may be formed on the conductive pattern 232 of the redistribution structure 230 to be electrically coupled to the conductive connectors 211. The conductive bumps 240 may be ball grid array (BGA) connectors, solder balls, metal pillars, controlled collapse chip connection (C4) bumps, micro bumps, electroless nickel-electroless palladium-immersion gold technique (ENEPIG) formed bumps, or the like. In some embodiments, the conductive bumps 240 are formed by forming a solder material on the conductive pattern 232 and reflowing the solder material to shape the conductive bumps 240 into desired bump shapes. In alternative embodiments, the respective conductive bump 240 includes a metal pillar (e.g., a copper pillar) having substantially vertical sidewalls and a metal cap layer formed on the metal pillar, where the metal cap layer may include nickel, tin, tin-lead, gold, silver, palladium, indium, nickel-palladium-gold, nickel-gold, and/or the like.

Referring to FIG. 5E and with reference to FIG. 5D and FIG. 4C, a singulation process may be performed to cut off the dielectric layer 231 of the redistribution structure 230, the workpiece 210W′, and the planarized molded material 220″ so as to form individual semiconductor devices 200D. For example, a respective semiconductor device 200D includes a semiconductor die 210D′, the redistribution structure 230 covering the first surface 2101D′ of the semiconductor die 210D′, the conductive bumps 240 overlying the redistribution structure 230, and the optically molded layer 2202D covering the second surface 2102D′ of the semiconductor die 210D′. The sidewall 210DS' of the semiconductor die 210D′ may be substantially aligned with the sidewall 220DS' of the optically molded layer 220D and the sidewall 230DS of the redistribution structure 230. The sidewalls (210DS′, 220DS′, and 230DS) may collectively form a continuous (e.g., a straight) sidewall of the semiconductor device 200D. In some embodiments, a lateral dimension (e.g., a width) W1′ of the semiconductor die 210D′ is substantially equal to a lateral dimension (e.g., a width) W2′ of the optically molded layer 2202D and/or a lateral dimension (e.g., a width) W3′ of the redistribution structure 230.

The optically molded layer 2202D may include the light-guide element (e.g., a grating coupler) 2202AD provided on the outer surface and may be similar to the second portion 2202D of the optically molded layer 220D described in FIG. 4C. The semiconductor die 210D′ may include the optical I/O portion (or interface) provided on the second surface 2102D′ and optically coupled to the light-guide element 2202AD of the optically molded layer 2202D. The semiconductor die 210D′ may include at least one photonic component (not individually shown) which may convert electrical signals into optical signals transmitted by the light-guide element of the optically molded layer 2202D and/or convert optical signals from the light-guide element into electrical signals. It should be noted that although a single light-guide element of the optically molded layer 2202D is illustrated, the optically molded layer 2202D of the semiconductor device 200D may be modified to include more than one light-guide element coupled to other sides/surfaces of the semiconductor die 210D′, as mentioned in the previous embodiments.

By using the molding apparatus having at least one pre-formed pattern (e.g., 1141, 1141′, 1123G, 1122, and/or 1123M) as described in the present disclosure, the light-guide element(s) of the optically molded layer may be accurately formed at the predetermined positions. In addition, by using the two-step alignment during the molding process, the workpiece may be accurately aligned with respect to the light-guide elements of the optically molded layer. Further, the molding apparatus described in the present disclosure may be used in mass production, and the processing steps for forming the semiconductor device may be reduced while manufacturing yields may be increased.

Other features and processes may also be included. For example, testing structures may be included to aid in the verification testing of the 3D packaging or 3DIC devices. The testing structures may include, for example, test pads formed in a redistribution layer or on a substrate that allows the testing of the 3D packaging or 3DIC, the use of probes and/or probe cards, and the like. The verification testing may be performed on intermediate structures as well as the final structure. Additionally, the structures and methods disclosed herein may be used in conjunction with testing methodologies that incorporate intermediate verification of known good dies to increase the yield and decrease costs.

According to some embodiments, an apparatus includes a mold chase and a sensor. The mold chase includes an upper portion and a lower portion engaged with the upper portion to form a cavity therebetween for receiving a workpiece. The upper portion includes a top surface and an alignment mark on the top surface. A pattern is provided on at least one of inner surfaces of the upper and lower portions. The sensor facing the mold chase is configured to detect the alignment mark of the upper portion and a position of the workpiece in the mold chase.

According to some alternative embodiments, a device includes a semiconductor structure and an optically molded layer covering the semiconductor structure. The optically molded layer includes a first light-guide element disposed over a first surface of the semiconductor structure and optically coupled to the semiconductor structure.

According to some alternative embodiments, a method includes forming an optically molded layer by using a molding apparatus. The optically molded layer is formed by: engaging an upper portion of a mold chase with a lower portion of the mold chase to form a cavity, where a pattern is provided on at least one of inner surfaces of the upper and lower portions; filling the cavity with a moldable material; and curing the moldable material. The mold chase imprints the pattern in the moldable material to form the optically molded layer with a corresponding pattern, and the corresponding pattern functions as a light-guide element.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An apparatus, comprising:
a mold chase comprising:
an upper portion comprising a top surface and an alignment mark on the top surface; and
a lower portion engaged with the upper portion to form a cavity therebetween for receiving a workpiece, wherein a pattern is provided on at least one of inner surfaces of the upper and lower portions; and
a sensor facing the mold chase and detect the alignment mark of the upper portion and a position of the workpiece in the mold chase.

2. The apparatus of claim 1, wherein the lower portion of the mold chase comprises:
a base; and
protrusions protruding from the base and arranged to form the pattern.

3. The apparatus of claim 1, wherein the lower portion of the mold chase comprises:
a wall; and
the pattern recessed from the wall.

4. The apparatus of claim 1, wherein the lower portion of the mold chase comprises:
a wall; and
a slanted inner surface provided on the wall and acting as the pattern.

5. The apparatus of claim 1, wherein a bottom surface of the upper portion of the mold chase comprises a plurality of concave recesses arranged to form the pattern.

6. The apparatus of claim 5, wherein the alignment mark on the top surface of the upper portion of the mold chase is disposed directly above one of the concave recesses.

7. The apparatus of claim 1, wherein a bottom surface of the upper portion of the mold chase comprises a plurality of convex protrusions arranged to form the pattern.

8. The apparatus of claim 1, wherein a pair of engagement parts are provided on peripheries of the upper and lower portions of the mold chase.

9. A device, comprising:
a semiconductor structure; and
an optically molded layer covering the semiconductor structure, the optically molded layer comprising a first light-guide element disposed over a first surface of the semiconductor structure and optically coupled to the semiconductor structure.

10. The device of claim 9, wherein the semiconductor structure is wrapped around by the optically molded layer.

11. The device of claim 9, wherein the optically molded layer comprises a second light-guide element disposed over a second surface of the semiconductor structure and optically coupled to the semiconductor structure, and the first and second surfaces of the semiconductor structure are opposite to each other.

12. The device of claim 9, wherein the optically molded layer covers a sidewall of the semiconductor structure and comprises a second light-guide element facing the sidewall of the semiconductor structure and optically coupled to the semiconductor structure.

13. The device of claim 9, wherein the optically molded layer comprises:
a first portion covering the first surface of the semiconductor structure; and
a second portion covering a second surface of the semiconductor structure opposite to the first surface, wherein a sidewall of the semiconductor structure is substantially aligned with sidewalls of the first portion and the second portion.

14. The device of claim 9, further comprising:
a redistribution structure overlying a second surface of the semiconductor structure opposite to the first surface, the redistribution structure being electrically coupled to the semiconductor structure.

15. The device of claim 14, wherein sidewalls of the redistribution structure, the semiconductor structure, and the optically molded layer are substantially aligned with one another.

16. A method, comprising:
forming an optically molded layer by using a molding apparatus comprising:
engaging an upper portion of a mold chase with a lower portion of the mold chase to form a cavity, wherein a pattern is provided on at least one of inner surfaces of the upper and lower portions;
filling the cavity with a moldable material; and
curing the moldable material, wherein the mold chase imprints the pattern in the moldable material to form the optically molded layer with a corresponding pattern, and the corresponding pattern functions as a light-guide element.

17. The method of claim 16, further comprising:
embedding a workpiece in the moldable material, wherein after forming the optically molded layer, the workpiece is wrapped around by the optically molded layer and optically coupled to the optically molded layer.

18. The method of claim 17, further comprising:
aligning the workpiece with the pattern of the mold chase by using a sensor, wherein the sensor facing the mold chase is configured to detect an alignment mark on an outer surface of the mold chase and a position of the workpiece in the mold chase.

19. The method of claim 17, wherein embedding the workpiece in the moldable material comprises:
placing the workpiece on the lower portion of the mold chase; and
dispensing the moldable material to cover the workpiece after placing the workpiece.

20. The method of claim 17, wherein embedding the workpiece in the moldable material comprises:
dispensing the moldable material to cover the workpiece; and
placing the workpiece on the lower portion of the mold chase after dispensing the moldable material.
